(19) United States
(12) Patent Application Publication
(10) Pub. No.: US 2010/0098902 A1
(43) Pub. Date: Apr. 22, 2010

(54) Layer-by-layer assemblies having preferential alignment of deposited axially anisotropic species and methods for preparation and use thereof

(76) Inventors: Nicholas Kotov, Ypsilanti, MI (US); Bong Sup Shim, Ann Arbor, MI (US); Paul Podsiadlo, Westland, MI (US)

Correspondence Address: HARNESS, DICKEY & PIERCE, P.L.C., P.O. BOX 828, BLOOMFIELD HILLS, MI, 48303, US

(21) Appl. No.: 11/514,053

(22) Filed: Aug. 31, 2006

Related U.S. Application Data
(60) Provisional application No. 60/713,071, filed on Aug. 31, 2005.

(51) Int. Cl. B32B 5/12; B05D 1/38

(52) U.S. Cl. 428/105; 427/470; 977/742

(57) ABSTRACT

Methods are provided for making layer-by-layer assemblies that comprise axial geometry nanoparticles. Such methods include forming a first layer on a substrate that comprises an axial nanoparticle, forming a second layer on the substrate that comprises an axial nanoparticle, where the first and second layers are aligned to respective first and second orientations. The disclosure also provides for multilayer materials having a first layer including a first polyelectrolyte and a first axial geometry nanoparticle which is substantially aligned along a first orientation. The multilayer material also includes a second layer including a second polyelectrolyte and a second axial geometry nanoparticle species having axial geometry, where the second nanoparticle species is substantially aligned along a second orientation which is distinct from the first orientation.

### CROSS-REFERENCE TO RELATED APPLICATIONS

This application claims the benefit of U.S. Provisional Application No. 60/713,071, filed on Aug. 31, 2005, the disclosure of which is incorporated herein by reference in its entirety.

### GOVERNMENT RIGHTS

This invention was made with government support under Contract Nos CHE-9876265 and BES-0350626 awarded by the National Science Foundation. The government has rights in the invention.

### FIELD

The present disclosure relates to nanoscale materials and more particularly to nanocomposite materials.

### BACKGROUND

Preparation of high performance nanostructured composites having nanoscale particles and polymer matrices has received increasing interest in the recent years. Carbon nanotubes (CNTs), in particular, have received wide attention due to their low density, as well as excellent mechanical and electrical properties. However, utilization of this material for the preparation of hybrid composites can pose issues due to the difficulty of generating stable dispersions, partly because of the highly hydrophobic surface of CNTs. In addition, for the purpose of large scale production, certain nanoscale materials are prohibitively expensive, and until the material and processing costs are lowered and easier preparation techniques are developed, it is unlikely that nanocomposites can be utilized in large scale manufacturing, aside from certain niche high value—added applications.

Further, controlled alignment of anisotropic nanoscale particle building blocks such as nanotubes, nanorods, and nanowires is considered a critical factor for fabricating functional nanocomposites which have anisotropic physical properties with exceptionally high nanomaterial content. For example, the exceptional physical and chemical properties of single-wall carbon nanotubes (SWNTs) are closely related to their highly anisotropic geometrical structures; hollow tubular structures with a diameter of few nanometers and a length of a few micrometers. As mentioned above, SWNTs have highly hydrophobic surfaces and have posed challenges for incorporating them into certain materials. Further, effective alignment of SWNT particles has been a particular challenge, with attempts utilizing various means, such as gas flow, liquid flow, magnetic field application, electric field application, and gas-liquid interfacial fields having only marginal effectiveness. For example, magnetic field techniques have been used to provide orientation to non-modified SWNTs, but require such high field strengths that they are impractical for use in common industrial applications and bulk manufacturing. Further, coatings having nanoscale particles (such as SWNTs) with parallel orientation can be developed with such techniques on a small scale; however, an economical, effective method for making large-scale bulk nanoscale composites having controlled non-parallel alignment is needed. Hence, it is desirable to develop nanocomposite materials that can economically be scaled up to result in economical bulk manufacturing, while having superior material properties.

### SUMMARY

According to various aspects, the present disclosure provides a method of making a layered material. The method comprises providing a substrate having a surface with at least one region having a charge. The first layer is formed by sequentially contacting the region with a solution and a second solution, where the first solution comprises a first charged species and the second solution comprises a second charged species. The first charged species has a charge opposite to that of both the surface of the substrate and of the second charged species. In addition, the first charged species comprises one of an axial nanoparticle and a polyelectrolyte and the second charged species comprises the other of the axial nanoparticle and polyelectrolyte. The first charged species overlies the region of the surface and the second charged species overlies the first charged species, thereby forming a first layer. The first layer is aligned comprising the axial nanoparticle and the polyelectrolyte to a first orientation. A second layer is formed by sequentially contacting the region overlaid with the first layer with the first and second solutions. The second layer is aligned comprising the axial nanoparticle and the polyelectrolyte to a second orientation.

In another aspect, the present disclosure provides a multilayer material comprising a first layer comprising a first polyelectrolyte and a first nanoparticle species having axial geometry, wherein the first nanoparticle species are substantially aligned along a first orientation. The aspect further provides a second layer comprising a second polyelectrolyte and a second nanoparticle species having axial geometry, wherein the second nanoparticle species are substantially aligned along a second orientation which is distinct from the first orientation.

According to other aspects, the present disclosure provides a method of making a layered material. The method comprises providing a substrate having a surface with at least one region having a charge. A first layer is formed by sequentially contacting the at least one region with a first solution and a second solution. The first solution comprises a first charged species and the second solution comprises a second charged species, with the first charged species has a charge opposite to that of both the surface of the substrate and of the second charged species. Further, the first charged species comprises one of an axial nanoparticle and a polyelectrolyte. The second charged species comprises the other of the axial nanoparticle and the polyelectrolyte. The first charged species overlies the region of the surface and the second charged species overlies the first charged species, thereby forming the first layer. The first layer is aligned comprising the axial nanoparticle and the polyelectrolyte to the orientation.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

Various aspects of the present disclosure will become more fully understood from the detailed description and the accompanying drawings, wherein:

FIG. 1A shows types of aligned single walled carbon nanotube (SWNT) composites that include vertical, horizontal-linear and horizontal-cross oriented SWNT films as well as fibers and tubes;

FIG. 1B shows a simplified experimental setup for SWNT combing, which produces a horizontal-linear alignment of SWNTs in a layer-by-layer (LBL) film. Pressurized air flow with 15 psig is applied to a LBL substrate which has SWNT layers with a 10 mm gap;

FIG. 1C shows a schematic expression of SWNT combing by air-water interfacial forces;

FIGS. 2A-2D show an atomic force microscopy (AFM) height image. FIG. 2A shows a randomly adsorbed SWNT LBL assembly having 3 layers and demonstrates the high density loading of SWNTs with single stranded dispersions. FIG. 2B shows an AFM phase image of aligned SWNTs by SWNT combing which changes the topography of 1 layer of [PVA/SWNT+poly(4-styrene sulfonate) (PSS)]₁ LBL assembly from random adsorption to stretched alignment. FIG. 2C shows an AFM phase image of aligned SWNT in a multiple layered LBL assembly, [PVA/SWNT+PSS]₂. FIG. 2D shows a scanning electron microscope (SEM) image of aligned SWNT in a multiple layered LBL assembly, [PVA/SWNT+PSS]₃. The bar in the images represents 1 micrometer each;

FIG. 3 depicts a height sectional analysis of aligned SWNTs, around 1 nm of height showing aligned SWNTs are well dispersed as a single stranded SWNT. The bar in the image represents 1 micrometer;

FIG. 4 shows a polarized absorption spectra of an aligned SWNT LBL film with perpendicular and parallel orientations to the incident polarized light;

FIGS. 5A and 5B show evolution of a growing composite determined where FIG. 5A shows UV-vis absorbance at 360 nm and FIG. 5B shows an ellipsometer after each deposition of cellulose nanocrystals;

FIGS. 6A-6F show a tapping mode AFM image of surface topography for a single poly(dimethyldiallylammonium chloride) (PDDA)/Cellulose Nanocrystal (CellNs) bilayer on a silicon substrate. FIGS. 6A and 6 B show topography and phase images of 10 μm*10 μm area which are SEM and AFM images of one aspect of the present disclosure, showing larger crystals. FIGS. 6C and 6D show topography and phase images of 5 μm*5 μm area which are SEM and AFM images of one aspect of the present disclosure. FIGS. 6E and 6F show topography and phase images of 1 μm*1 μm area which are SEM and AFM images of one aspect of the present disclosure;

FIGS. 7A and 7B show SEM images of a single PDDA/CellNs bilayer on a silicon substrate at 50 k (FIG. 7A) and 200 k (FIG. 7B) magnifications;

FIG. 8 shows an exemplary multi-layer assembly according to the principles of the present disclosure, where each layer has a distinct orientation corresponding to an alignment of nanofibers, where an angle between each respective alignment orientation forms a pitch of a spiral assembly that can be changed by modifying a shift angle in each respective layer. The pitch determines the optical properties of the final material and its ability to-function as, for instance, optical bang-gap material’

FIG. 9 shows the effect of a method of de-wetting in conjunction with an alignment process in accordance with various aspects of the present disclosure; and

FIGS. 10A-10D depict scanning electron microscope (SEM) images a structure of de-wetted layers. FIGS. 10A and 10B shows different stages of de-wetting of layers having axial geometry nanoparticles without air applied for alignment, as where FIGS. 10C and 10D depict SEM images of de-wetted layers having axial geometry nanoparticles where air alignment is combined with de-wetting effect.

### DETAILED DESCRIPTION

The following description of the preferred embodiment(s) is merely exemplary in nature and is in no way intended to limit the present disclosure, its application, or uses.

In various aspects of the present disclosure, nanoparticles (e.g., colloids, or solids, in a colloidal suspension) are integrated into a multilayer assembly to form improved materials. In various embodiments, the nanoparticles are anisotropic having a cylindrical or rod shape with an elongated axis, thus having an axial anisotropic geometry. Generally, an aspect ratio (AR) for cylindrical shapes (e.g., a rod or fiber) is defined as AR=L/D where L is the length of the longest axis and D is the diameter of the cylinder or fiber. Exemplary nanoparticles suitable for use in the invention generally have high aspect ratios, ranging from about 500 to 5,000, for example, where an average diameter of the nanoparticles ranges from less than 1 nm to about 30 nm, and the length of the nanoparticles can be from several hundred nanometers to greater than 10 μm.

One aspect of the present disclosure is the ability to align such nanoparticles in respective individual layers of a material that form the multilayer assemblies. Such a feature provides the superior control and design capability of the material's properties, as will be described in more detail below.

In various aspects of the present disclosure, the multilayer material assemblies are made by a layer-by-layer assembly technique (LBL) that demonstrates exceptional uniformity and versatility for constructing a nanostructure composite with various nanobuilding blocks, including SWNTs. In certain aspects, the disclosure provides a method of forming a layer-by-layer assembly comprising forming a first layer comprising at least one nanoparticle species, where the first layer has a first orientation. The method also comprises forming a second layer comprising at least one nanoparticle species and having a second orientation, where the first orientation and the second orientation are distinct from one another. In other aspects of the present disclosure, the method provides for forming a plurality of layers, wherein at least one layer of the plurality of layers has a first orientation and at least one layer of the plurality of layers has a second orientation that is distinct from the first orientation.

In various aspects of the present disclosure, oriented materials are prepared that comprise nanoparticles that are artificial, natural fibrous, and/or rod-like colloids. In various embodiments, the oriented materials are prepared by a layer-by-layer assembly technique with polyelectrolytes. Layer-by-layer assembly techniques are described in U.S. Pat. No. 5,208,111 to Decher et al., U.S. Pat. Nos. 6,316,084 and 6,447,887 both to Claus et al. each of which are herein incorporated by reference in their respective entireties. A brief description of layer-by-layer assembly is provided herein.

A layer is generally believed to be formed by the assembly of a single layer of an organic or polymer molecule followed by a layer of inorganic particles (or alternatively clusters of particles, where the average particle size is on a nanoscale, for example less than 30 nm) in a layer-by-layer fashion at room temperature. The combination of nanoscale particles or clusters (generally having a particle size less than about 30 nm) and flexible organic (or polymer) molecules makes it possible to fabricate films tens to hundred of micrometers in thickness. The technique further allows control of coating refractive index, as will be discussed in more detail below.

The process of forming an assembly by the layer-by-layer technique can generally includes the steps of: 1) providing a substrate; 2) optionally modifying the substrate to impart a charge; 3) contacting the substrate with a colloidal suspension comprising the nanoparticles and a solvent, so that the nanoparticles overlie the target substrate; 4) rinsing the substrate with cleansing solution; 5) contacting the substrate with a polymer solution comprising a polyelectrolyte; where the polyelectrolyte overlies the target deposited nanoparticles 6) rinsing the substrate with cleansing solution; 7) repeating the steps of 3) to 6) to yield a multilayer coated substrate. The solutions in step 7) can be the same as, or different from the solutions used in steps 3 to 6, or the mixture of two or more nanoparticle species or polymer species. It should be appreciated that the term “overlies” can include any joining, coupling, bonding, attaching, or other mechanism, such as electrostatic attraction, adsorption, absorption, ionic bonding, and the like recognized by one of skill in the art as promoting a long-term connection of the charged species to the selected target. The resulting multilayer coatings can consist of different blocks of inorganic nanoparticles and polymer (or organic molecules).

Multi-layer assembly systems of the type described above comprise at least two materials having ionic groups of opposite charges. Thus, the simplest layer sequence is of the ABABAB type. However, the functionality of the layers can be selectively increased by using more than 2 materials. For example, ABCBABABCB or ABCDCBADCBAC, in which A and C and B and D carry the same charge. The layer sequence is a consequence of the selection of the dipping bath used in each case for applying the individual layers.

The layer-by-layer assembly formation process allows production of large-area ordered multi-layered layer elements. Suitable supports for the layer elements according to the disclosure are those having a surface which is flat and accessible to solvents, for example flat, cylindrical, conical, spherical or other supports of uniform shape, which thus also include interior surfaces of bottles, tubings, and the like. Support substrates having a flat surface are preferred. For various optical or electrical areas of application, the support substrates can be transparent, impermeable or reflecting as well as electrically conducting, semi-conducting or insulating. The chemical nature of these substrates can be inorganic or organic. Examples of inorganic support materials are described in U.S. Pat. No. 5,208,111, incorporated herein by reference in its entirety, and include metals, semi-conductor materials, glasses or ceramic materials, such as gold, platinum, nickel, palladium, aluminum, chromium, steel and other metals, germanium, gallium arsenide, silicon and other semi-conductor materials, glasses of a wide range of chemical composition, quartz glass, porcelain, and mixed oxides, which are understood to mean ceramic materials. Further inorganic substances which are suitable as substrate supports are, for example, graphite, zinc selenide, mica, silicon dioxide, lithium niobate and further substrate materials, if desired in the form of inorganic single crystals, such as are known to those of skill in the art.

Organic materials for the support substrates can be selected to be polymer materials, due to the dimensional stability and resistance to solvents. Suitable examples are: polyesters, such as polyethylene terephthalate, polybutylene terephthalate and others, polyvinyl chloride, polyvinylidene fluoride, polytetrafluoroethylene, polycarbonate, polyamide, poly(meth)acrylate, polystyrene, polyethylene or ethylene/vinyl acetate copolymer, or other substrate materials suitable for Langmuir-Blodgett (LB) (e.g., layer-by-layer) technology, as are generally known to one of skill in the art. The list of materials recited above is merely exemplary and non-limiting.

Preferably, the substrate materials have charged or ionizable surfaces, or alternatively, their surfaces are modified such that substantial regions of the surface of the substrate are covered with ions or ionizable compounds having the same charge. Thus, a first monomolecular layer is solidly attached to the substrate over the charged surface. However, the application of ions or ionizable compounds over the entire area of the substrate can also be effected by a chemical reaction on the support substrate surface itself, in which the surface is densely covered with ions or ionizable groups having the same charge to form a monomolecular layer. Such a modification is known to one skilled in the art and working in the area of multi-layered thin films. Examples of these are self-assembly monolayers, for example, comprise an α,ω-dithiol, cysteamine, amino-containing thiols and other thiols containing a further ionic or ionizable group, on metals, such as gold, silver, cadmium and others. In this case, the thiol group is solidly bound to the metallic surface and the second thiol group, a carboxyl group, an amino group or another ionic or ionizable group forms the ionic modification of the metallic support to be used. A further example is silanation of the surface with silanes containing alkoxy groups, which additionally contain a further ionic or ionizable group. This silanation is possible with all silicon-containing support substrates in a manner known to one skilled in the art. The ionic or ionizable group can be, for example, a sulfur group or an ionizable amino group.

Another example relates to the chemical modification of polymeric organic supports (polymer-analogous reaction). Thus, for example, polyethylene can be provided on the surface with carboxyl groups by means of oxidizing agents, such as chromic acid. Methacrylate or methacrylamides can also be provided on the surface with carboxyl groups by means of hydrolysis. Sulphonation of polystyrene resins on the surface also leads to a modification utilizable according to the present disclosure, such materials are also known as flat ion exchangers. Furthermore, it is known to one skilled in the art that instead of anionic groups (carboxyl groups, sulfo groups), cationic groups, such as amino groups, can also be obtained by chloromethylation, followed by the introduction of an amino group. Reactions of this type are known as polymer-analogous reactions.

Additionally, freshly split mica can be used, which has a negatively charged surface on which cationic compounds can be adsorbed directly. Furthermore, for glass or quartz, it is also possible to adsorb cationic compounds, such as polyethyleneimine, after a short dipping period in sodium hydroxide solution. One important aspect of the substrate is that it has at least one surface that has a relatively even and high charge density of ions and/or ionizable groups. It is also preferable that the ions and/or ionizable groups on the surface of the substrate have the same charge.

The organic materials that form the individual layers on the substrate can be either monomeric substances having two ionic or ionizable functional groups of the same charge (so-called bola amphiphiles) or polymers that have a multiplicity of ionic or ionizable functional groups of the same charge (so-called “polyelectrolytes” or “polyionenes”). These organic materials preferably carry functional groups of the same charge (i.e., either cations or groups which can be ionized to cations or anions or groups which can be ionized to anions). The organic molecules may comprise different cationic species (or species that can form cations) or different anionic species (or species that can form anions). However, for reasons of accessibility and ease of production, in certain aspects, the two functional groups in the monomeric substances are the same and that the multiplicity of the functional groups in the polymers are also the same.

In certain aspects, a polyelectrolyte for the individual layers of the LBL assembly is selected from the group poly(4-styrene sulfonate) (PSS), poly-ethyleneimine, polyallylamine, polyvinyl alcohol (PVA), poly(acrylic) acid, polymers with condensed aromatic ring structures, amphiphilic co-polymers, DNA, proteins, surfactants, and mixtures thereof.

In various aspects of the present disclosure, the layer-by-layer assembly comprises one or more nanoparticles. Preferably, such nanoparticles have anisotropic properties and an axial geometry with an elongated axis. The nanoparticles can be selected from nanotubes, nanowires, nanowhiskers, nanofibers, nanocrystals, or any other suitable nanoscale materials (having an average particle diameter of less than about 1 μm, optionally less than about 500 nm, optionally less than about 100 nm, optionally less than about 50 nm, and in certain embodiments less than about 10 nm), as are well known to one of skill in the art. Suitable nanoparticles include carbon nanotubes, semiconductor materials, metallic fibers and rods, magnetic rods, nanowires, fibrous and rod-like polymers, and other nanoscale species with axial geometry. The aligned axial particles, particularly those particles made from metallic species and/or good electronic conductors, can be organized to produce negative refractive index materials by varying the density of the rods and the distance between the rods in the direction perpendicular to the substrate that can be varied by the insertion of polyelectrolyte layers. Thus, the selection of the nanoparticles is specific to the ultimate application in which the material will be used. In certain embodiments, the nanoparticles, or colloids comprise cellulose nanocrystals that are used in multilayer assemblies. In other embodiments, the nanoparticles are carbon nanotubes, such as single walled nanotubes (SWNTs) or multi-walled nanotubes (MWNTs), for example.

In certain aspects, one or more layers of the LBL can be cross-linked, for example, by using specific chemical agents known to those of skill in the art that form covalent and ionic bonds with the components of the multilayers. Examples of covalent cross-linking include glutaraldehyde and similar compounds that have two or more functional groups on the chain of atoms or compounds capable of forming amide bonds with the LBL components. In another aspect, ionic cross-linking of the films is contemplated where the addition of simple inorganic ions such as iron, chromium, aluminum, borax and other similar species results in formation of strong ionic bonds or semi-covalent bonds with the functional groups of the LBL components. In various aspects, the cross-linking procedure is optionally employed after each layer or after a pre-selected number of layers have been deposited. Such cross-linking improves mechanical, optical and electrical properties of the LBL films.

As described above, in certain embodiments, a first layer of a multilayer assembly material has a first orientation and a second layer has a second orientation. In one embodiment, the first and second orientation may be parallel to one another. In another embodiment, the first and second orientations are distinct from one another and their alignment is off-set by an orientational angle. Thus, the principles of the disclosure allow for varying the relative orientational angle from one layer to another, affording gradual rotation of the preferential alignment of the above mentioned nanoparticle materials in the plane of the substrate. The control over the orientation of each respective layer in a multi-layer assembly permits the design of the material, as is suitable to a variety of different applications.

For example, the materials having such properties can be designed to be assembled as optically active materials. For example, lyotropic liquid crystal structures can be formed that have a pitch of a spiral and degree of rotation in each layer, which can be varied to achieve desired material properties and/or characteristics. Such materials will have properties of the lyotropic liquid crystals and can be used in all fields requiring such properties. For example, one such lyotropic material is a cholesteric liquid crystal that can be used for various applications, such as reflective displays, reflective polarizers, optical sensors, and lasers, inter alia.

Other aspects of the present disclosure include the formation of a lyotropic liquid crystal with a nanocomposite material having a nanoparticle with an axial geometry that is assembled in the layer-by-layer fashion by applying one of the alignment procedures. Between each layer the alignment or orientation angle is shifted by a pre-determined number of degrees as is indicated in FIG. 8. The pitch of the spiral assembly of the cellulose fiber can be varied by changing the shift angle in each layer. The pitch will determine the optical properties of the final material and its ability to function as, for instance, optical bang-gap material.

In various embodiments, the assemblies of the present disclosure provide vast flexibility in the design of such materials, because the high degree of control in the formation and alignment of each layer does not limit the construction and properties of the liquid crystals based on the properties of the fibers or particles themselves. Such materials formed in accordance with various aspects of the present disclosure also have unique mechanical and electrical properties. In this regard, the materials of the present disclosure are also useful as flexible and strong composite materials and coatings.

In various aspects of the present disclosure, the LBL films made from conductive nanoparticles, such as carbon nanotubes and similar conducting axial materials, are highly conductive and excellent conductors of electricity. The preferential alignment of such LBL films can be used to increase or decrease the conductivity along certain or all directions in the films. Control of layer alignment with a particular pattern is useful for the preparation of conducting films that change the direction of preferential conductivity from layer to layer or a system of several layers to another system of several layers. In various aspects, the ionic, covalent cross-linking described above and other treatments can be used to alter the type of conductivity in the films having conductive axial geometry particles and achieve p- or n- conductivity, as desired.

Thermo-electric materials, for example, those materials that exhibit cooling when exposed to electric current, are generally rare because they are believed to require high electrical conductivity, but low thermal conductivity. Typically, materials that have high electrical conductivity likewise have high thermal conductivity. However, the materials formed according to certain aspects of the present disclosure can be designed to be thermoelectric materials, which have widespread applications. The multilayer assemblies can be designed to have high electrical conductivity but low thermal conductivity. In certain embodiments, the thermoelectric materials formed from assemblies according to the present disclosure comprise nanoparticle colloid rods that have an average diameter that is less than that of a phonon for the material (to promote scattering and prevent heat conduction), but a diameter greater than an electron (to promote electrical conductivity). In one example, the thermoelectric material has a herringbone type structure formed by the respective plurality of layers, where electrons are believed to be transmitted through the material by tunneling action.

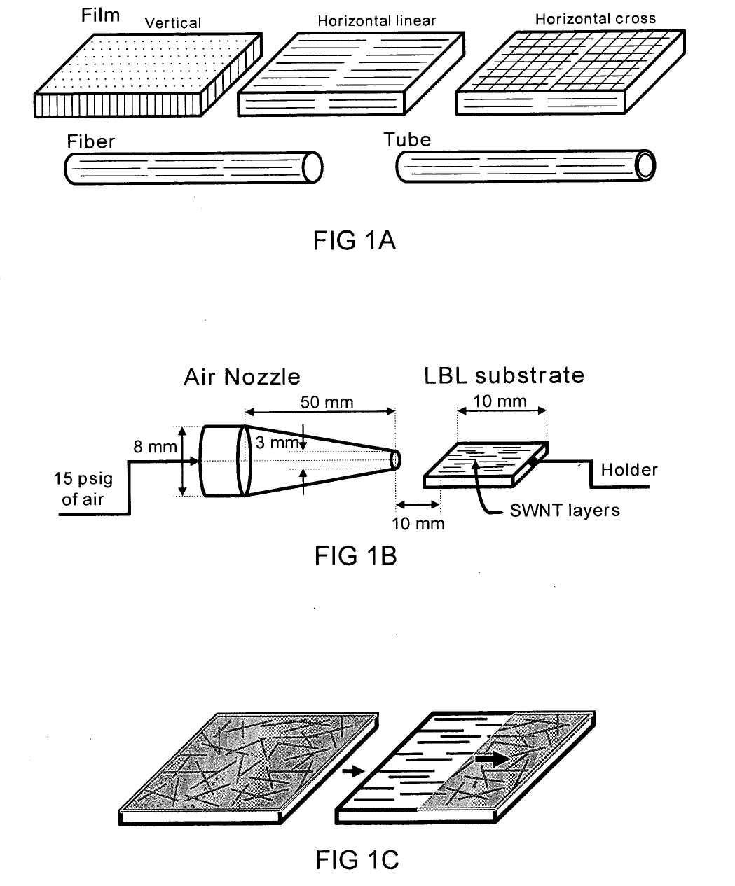

Certain aspects of the present disclosure provide nanocomposites formed by layer-by-layer (LBL) assembly, by employing a method that effectively aligns the axial geometry nanoparticles during LBL assembly. The method according to the principles of the present disclosure employs air-water interfacial force to align the nanoparticles, which can be termed “combing”, as is shown generally in FIGS. 1A-1B. Pressurized air flows over a wet surface with randomly adsorbed nanoparticles, and combs the layer. In some embodiments, the combing process also physically stretches the nanoparticles. The affect of the combing modifies the surface topography of the nanoparticles from random to a one directional orientation. This method is not only efficient to align nanoparticle layers (of which each layer can have a distinct orientation from other layers) but also robust enough to stack the multilayer through adoption of a high temperature annealing step for fixing aligned structures. A multilayered film material formed by LBL combined with combing demonstrates a high density of nanoparticle loading, for example, SWNT loading with horizontal-linear alignment of single-stranded SWNTs. In one aspect, the oriented structure of a SWNT nanocomposite film improves the functional performances of nanomaterials. Such an improved nanocomposite multilayer film can be used in any number of applications including biological tissue engineering, solar cell, artificial muscle, sensor, and a wide range of electronics. Furthermore, the methodological principle of combing is applicable to a variety of nanoparticles that have an axial geometry, including by way of non-limiting example, nanowires, nanorods, nanofibers, and the like, because the alignment driving forces are associated with the geometrical anisotropic feature and the interfacial bonding between the nanoblocks and the substrate, instead of the nanoparticle's intrinsic physical properties. The ability of LBL to deposit one layer of axial nanoparticle colloid at a time can also be used to prepare layers that have criss-crossed alignments, thus forming strong and robust composites that are expected to have record mechanical properties with respect to several key parameters essential for various applications, including biomedical and aerospace arts.

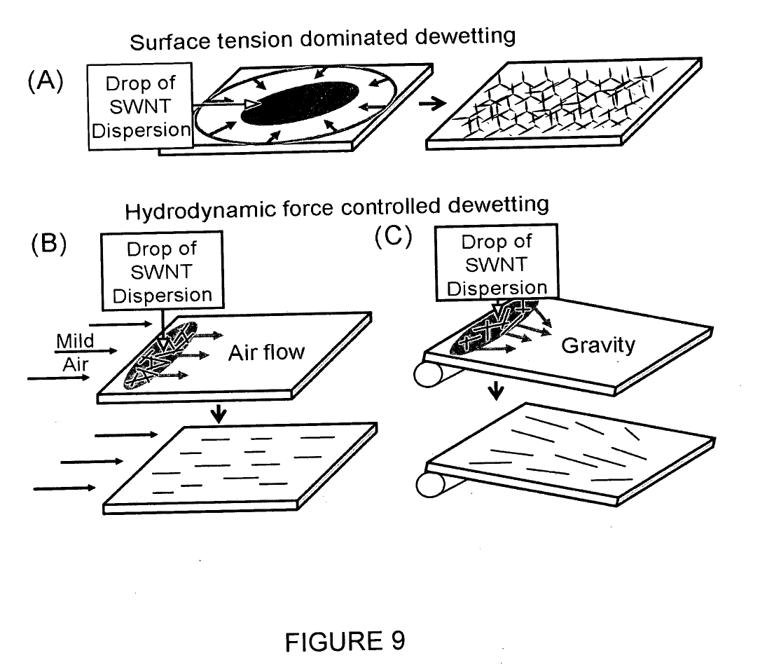

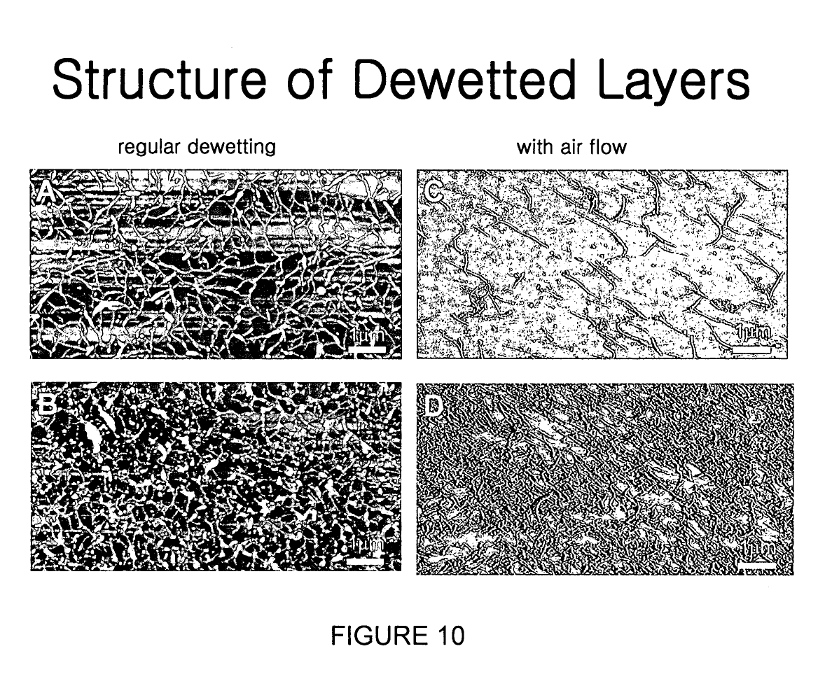

In certain embodiments, a de-wetting method can be employed in conjunction with the LBL formation and alignment methods described above, as is generally shown in FIGS. 9 and 10A-10D. Such a de-wetting method may eliminate the need for intermediate rinsing steps, often used for other LBL procedures. Thus, the disclosure provides methods of achieving alignment of the nanoparticle in the films that further includes the utilization of de-wetting affects by including a de-wetting component that is removed from the layer to provide additional alignment. Such a de-wetting component has a relatively high surface tension and can include a solvent, a carrier, or mixtures of solvents and/or carriers. Such a de-wetting component may be included in the solution forming the layer or may be introduced to the applied layer via spraying, atomization, or the like, where droplets or layers of solvent are formed on the layer. The de-wetting agent is then removed either by shaking, flow of air, directing a mechanical device (e.g., a bar sliding over the surface, or by gravity. Such a de-wetting method results in efficient alignment of the various components in the film, including axial geometry nanoparticles, and in some embodiments in a new organization of the components of the film due to surface tension effects, as is generally shown in the SEM images of FIGS. 10A-D.

In one aspect of the present disclosure, the LBL assembly comprises nanoparticles of single-walled nanotubes (SWNT) that form nanocomposite films. The nanocomposite films are thus assembled by LBL methodology described previously, where polymer is driven by different forces, such as electrostatic, donor-acceptor, and hydrogen bonding interactions. Such methods achieve LBL composites that have exceptional uniformity with a high degree of organization of single-stranded nanoparticle (SWNTs) dispersion. In some situations, achieving alignment of SWNTs in controlled directions while preserving a single-stranded dispersion quality of SWNTs has previously posed significant difficulties. It should be noted that some degree of organization of SWNT, i.e., restriction on their spatial orientation, is introduced by traditional LBL simply due to the nature of the adsorption process on the substrate and layers. SWNTs have inherently preferential in-plane orientation in LBL composites because nanotubes approaching the substrate surface in a perpendicular direction have difficulty with adhering to the polymer layer. The orientation effects can be observed particularly well for flat nanocolloids, such as clay sheets. However, in such processes, the overall degree of alignment of the nanoparticles was difficult to control well, and such control is desirable for improved material properties. Thus, the combing step, according to principles set forth in the present disclosure, has desirably provided a previously unattainable high degree of control and organized alignment of axial geometry nanoparticles, as will be described in more detail below.

In accordance with certain aspects of the present disclosure, purified non-modified nanotubes, which have a hydrophobic and inert surface are pre-treated and mixed with a compound that coats the surface of the nanotube and further provides a charge to the otherwise inert surface of the nanotube. In some aspects, the pre-treatment compound contains a hydrophobic portion that interacts with the hydrophobic surface of the nanotube particles and further contains one or more charged moieties. The charged moieties of the pre-treatment compound enable the inert nanotubes to be used successfully in a layer-by-layer assembly process which employs charge for the electrostatic assembly of the layers. As appreciated by one of skill in the art, such pre-treatment compounds are useful for any nanoparticles which have inert and/or hydrophobic surfaces. Non-limiting examples of suitable pre-treatment compounds include poly(4-styrene sulfonate) (PSS), poly-ethyleneimine, polyallylamine, polyvinyl alcohol (PVA), poly(acrylic) acid, polymers with condensed aromatic ring structures, amphiphilic co-polymers, DNA, proteins, and surfactants.

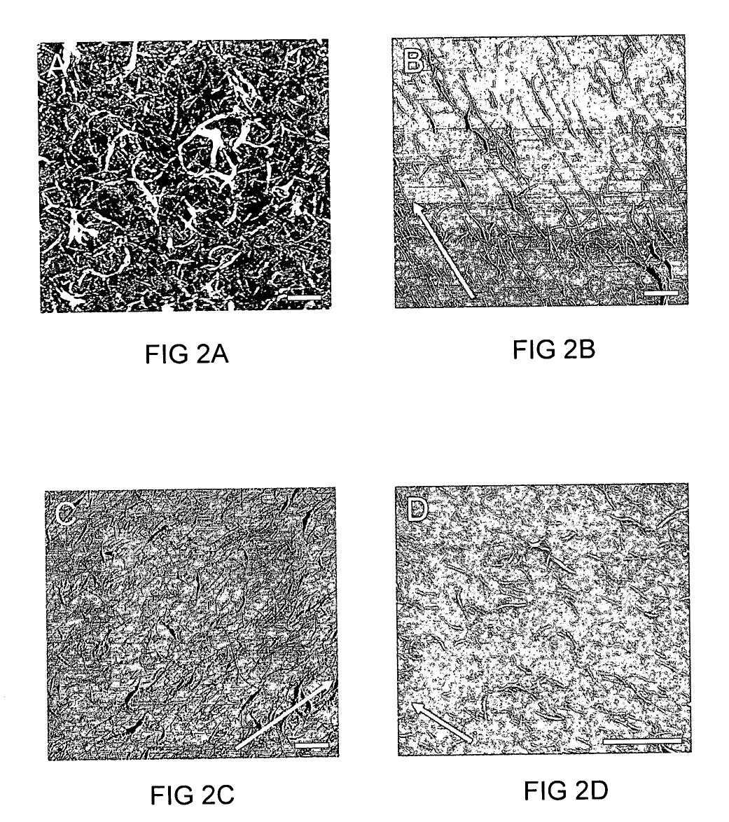

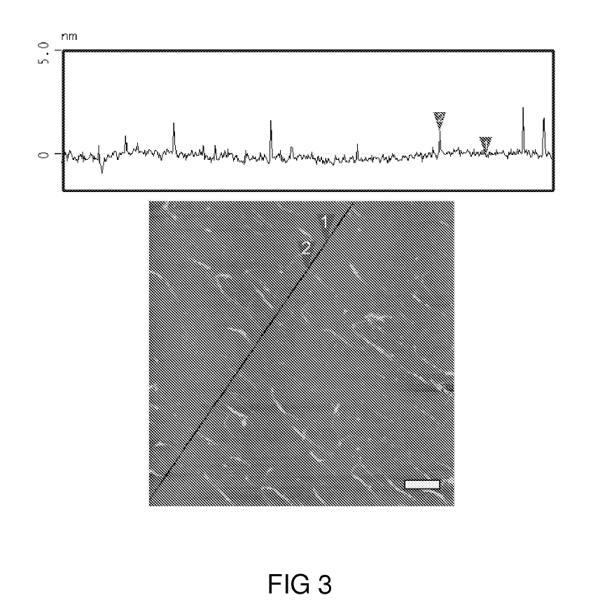

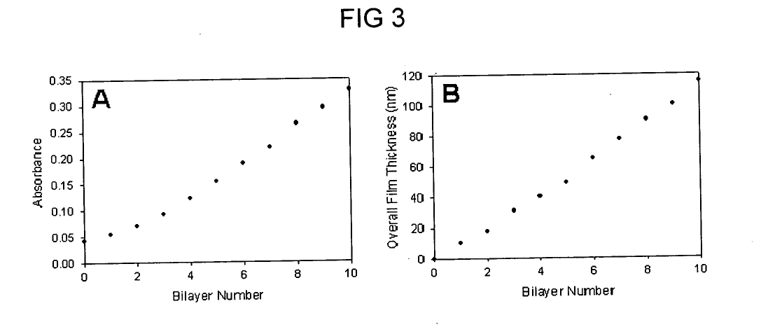

Purified high-pressure CO conversion synthesis (HiPco) SWNTs, which are commercially available from Carbon Nanotechnologies, Inc., are dispersed in a poly(4-styrene sulfonate) (PSS) solution, as will be described in more detail in the Examples below. Dispersed SWNTs wrapped by PSS form one LBL assembly component and poly(vinyl alcohol) becomes a second component and its LBL partner, enabling sequential adsorption on a substrate. On a charged substrate, these two components are assembled with sequential dipping processes in each respective component, followed by an interim rinsing step, which removes excess non-adsorbed components from the surface. A drying step stabilizes the newly formed molecular layer. The orientation step of the assembly process, i.e., nanotube combing, is carried out during these interim drying steps which follow the rinsing of excess SWNTs on the PVA surface. Pressurized air blowing, for example at about 1.5 psig, makes the randomly oriented SWNTs stretch and align by air-water interfacial forces (for experimental schematics, see FIGS. 1A-1C). The images in FIG. 2A-2D show that most of SWNTs on the PVA surface are not just aligned in one direction but also stretched, as will be described in greater detail below. The most apparent feature of this SWNT combing method is the alignment of mostly single-stranded SWNTs whose diameters are around about 1.0 to about 1.4 nm. (FIG. 3) Thus, in various aspects of the present disclosure, single-stranded non-bundled SWNTs with high density are successfully aligned. In addition, the alignment efficiency is extremely high with more than 80% of SWNTs aligned unidirectionally with less than ±5° of angular deviation from the alignment axis. (FIG. 2B). The SWNTs are combed by the strong viscous drag forces of a fast moving air-water interfacial meniscus generated by pressurized air flow after SWNTs have been randomly attached to the surface.

Certain methods of the present disclosure as described here are better suited for the preparation of aligned flat composites, mainly due to the presence of the polymer and larger amounts of SWNTs involved, as well as excellent demonstrated efficiency. SWNT combing after random deposition of SWNTs can achieve both the high density of SWNTs and high degree of orientation because these two processes, namely deposition and orientation, are performed in two distinct steps.

In fluid dynamic approaches, a liquid flow driven alignment of SWNTs is less efficient because the velocity in wall areas becomes zero even with high bulk flow velocity, given the height of SWNTs, for example, an SWNT height of about 1 nm is lower than the height of two water molecules. However, the surface velocity of a receding meniscus in this SWNT combing appeared to be much higher than a few cm/s. It is believed that air-water interfacial forces are the key elements in SWNT combing. For example, where the degree of nanotube orientation in films obtained with various LBL procedures are compared, for instance, stagnant rinsing and drying as well as water flow rinsing, it becomes apparent air-water interfacial forces are believed to be important. When a substrate is dipped in a stagnant SWNT dispersion, a flow of pressurized air provides the most desirable extent of SWNT alignment, as no other condition resulted in as effective an orientation of SWNTs (FIG. 2A). Moreover, FIGS. 2C and 2D demonstrate that post LBL SWNT combing made the multilayer stacking possible because the subsequent polymer layer protected the aligned SWNTs. While not wishing to be bound by any particular theory, it has been hypothesized that immobilization of SWNT particles in the multilayers significantly improves mechanical properties of SWNT LBL composites.

An optional treatment in certain aspects of the present disclosure includes heat treating or thermal annealing. Thermal annealing at temperatures of less than the melting point of the polymer and/or nanoparticle, for example at 150° C. for a duration of 10 minutes can be conducted after each SWNT combing. Annealing appears to increase the alignment efficiency for obtaining different alignments between layers of multilayer composites. In an embodiment where nanoparticles comprise SWNTs, at elevated temperature, carboxyl groups (—COON) on SWNTs and hydroxyl groups (—OH) present on the polymer, for example, on PVA can form ester bonds. Even though the purified SWNTs were wrapped with the PSS, the ends of the SWNTs generally remain open due to higher possibility of existing carboxyl groups, which can then be connected to hydroxyl groups in PVA by cross-linking. Furthermore, heat treatment of an LBL film can closely pack the components, which results in confinement of SWNTs in their aligned states. Therefore, multiple layers of linearly weaved SWNTs, [PVA/(SWNT+PSS)]₃ having good alignment of SWNTs can be formed, as well as two bi-layers. (FIGS. 2C, 2D).

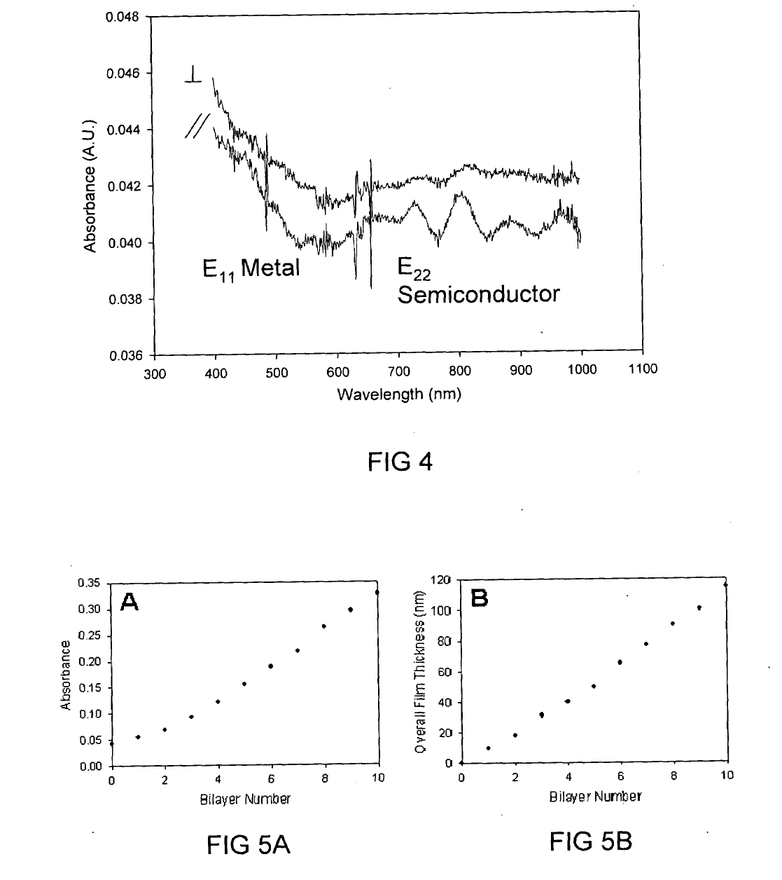

While not wishing to be bound by any particular theory, it is believed that alignment of SWNTs is considered to be a general macro-scale process, as opposed to micro/nanoscale localized effect. For example, polarized light absorption spectroscopy measurements show that where incident polarized light is parallel to the alignment direction of SWNTs, then absorbance decreases, however characterized light absorption peaks of SWNTs clearly emerge. (FIG. 4). These characterized peaks come from the van Hove singularities, which are the electronic transitions from the valence to conduction bands in both metallic and semiconducting SWNTs.

While not limiting, the theory of molecular combing for nanoparticle alignment is believed to be as follows. In the case of the combing of a nanoparticle, such as SWNTs, the velocity of a receding meniscus should be considered by association with the hydrodynamic drag force and the rate of intrinsic de-wetting along the SWNTs because the surface velocity is relatively much higher than that of DNA combing, for example. The hydrodynamic drag forces can be calculated by assuming a SWNT as a circular cylinder. The drag force per unit length on a cylinder of radius R is expressed by

$${F}_{D} = 4 π μ U ɛ [ 1 - 0.87 {ɛ}^{2} + O ( {ɛ}^{3} ) ] , \\ ɛ = {[ ln ( \frac{4}{Re} ) + \frac{1}{2} - ω ]}^{- 1} ,$$

where Re=UR/v,

$$v = \frac{μ}{ρ}$$

(kinematic viscosity), μ(viscosity), U(characteristic velocity) and ω(=0.5772 . . . ) is Euler's constant. The intrinsic de-wetting (not driven by external forces) velocity V which is related to the capillary and viscous dissipation forces is theoretically given by

$${V}_{slip} = \frac{1}{6} \frac{γ}{μ} {θ}^{2} \frac{b}{w}$$

(slipping film) or

$${V}_{no - slip} = \frac{1}{6} \frac{γ}{μ} {θ}^{2} \frac{θ}{L}$$

(nonslipping film) with γ(surface tension), θ(contact angle), b(slippage length), w(width of the rim), and L(constant of order 10). Based on these theoretical principles, the sheer force of SWNT combing effects is estimated to be the excess drag forces, which are caused by the differences between the surface velocity of the receding meniscus and the intrinsic de-wetting velocity along SWNTs. Furthermore, in order to avoid detaching the SWNTs from the surface, this excess hydrodynamic force should be less than the difference in adsorption forces of SWNTs between the wet and the dry states. From this analysis, the processing variables that increase the efficiency of SWNT alignment include the viscosity of a rinsing liquid, the surface tension of the liquid, the interaction between SWNTs and the surface, and the meniscus receding velocity which can be controlled by the air blowing pressure.

Thus, in certain aspects of the present disclosure, a technique is provided for alignment of axial geometry nanoparticle-polymer composites based on LBL assemblies. The axial geometry nanoparticle combing takes advantage of the air-water interfacial meniscus during a drying step in the LBL process. This technique is fast and efficient. Further, in certain embodiments, the methods produce SWNT-polymer nanocomposites with a single-strand quality and high density of SWNT stacking in a LBL composite. Analysis of SWNT alignment features suggests that the excess drag force of a receding air-water meniscus and the surface velocity of an intrinsic de-wetting are important in achieving desired SWNT alignment.

Anisotropic properties driven by orientation of SWNTs in polymer nanocomposites display very substantial physical effects in mechanical, electrical and thermal properties. For example, materials prepared in accordance with various principles of the present disclosure provide composites having single- or multi-walled carbon nanotubes with tensile strength, a, in excess of about 450 MPa (in some cases a as high as 500 MPa) and E ranging from about 13-43 GPa. These methods provide robust fabrication techniques for aligned SWNT-polymer nanocomposites. LBL films can prepare many such composites due to the ability to prepare films with any thickness and immobilization of previously deposited SWNT multilayers.

### Example 1

Poly(vinyl alcohol) (PVA, MW: 70,000 to about 100,000) and Poly(sodium 4-styrene-sulfonate), (PSS, MW: 1,000,000) were purchased from Sigma-Aldrich Co. Purified high-pressure CO conversion synthesis (HiPco) single-wall carbon nanotubes (SWNTs) used for the experiment were purchased from Carbon Nanotechnologies Incorporated (CNI).

The purified HiPco SWNTs are dispersed in 1 wt-% PSS solution with a 2 hr mild sonication in a VWR Model 150HT ultrasonic cleaner. The dispersion is centrifuged at 5000 rpm and then the supernatant is collected. 1 wt-% of PVA solution is prepared as an LBL partner. By charge transfer interaction, PSS, which are wrapping SWNTs, and PVA form LBL assemblies on a cleaned Si substrate (10 mm×5 mm). Each LBL layering process consists of 10 min dipping alternately in the PVA or the SWNT solution, water rinsing, and drying. For denoting LBL assemblies, [PVA/SWNT]ₙ is used in which n represents the number of repeated dipping processes in PVA and SWNT solutions. SWNT combing is performed by 15 psig of an air flow during this interim drying step following a water rinsing step. For a multilayered film with aligned SWNTs, a high temperature annealing step, 150 ° C. for 10 min, is followed in order to fix the aligned structures. Scanning electron microscopy (SEM) images are taken with a Philips XL30 Field Emission Gun Scanning Electron Microscope and a FEI Nova Nanolab Dualbeam FIB and Scanning Electron Microscope. Atomic force microscopy (AFM) imaging is performed with Nanoscope III (Digital InstrumentsNeeco Metrology Group). UV-vis absorption measurements are taken using an Agilent 8453E UV-visible spectroscopy and Newport PR-950 Broadband polarization rotator. These results are shown in FIGS. 2A-2D and FIG. 3, as discussed above.

In certain aspects of the disclosure, the assembly comprises nanowires or nanorods that comprise a precious metal, such as Au or Ag. Such nanocomposite materials are assembled in a similar manner to the one described above in the context of a SWNT nanoparticle. One of the variations of this approach is that the assemblies of the rods are connected to each other to control the distance between them. The distance control can be accomplished by coating of the rods and nanowires with insulating materials, or chemical attachment of spacer molecules that limit the approach of the rods/wires to each other. One of the examples of such molecules can be biological polymers, such as antigens, antibodies, DNA and other biological pairs with affinity to each other.

The rods will be assembled in aligned fashion using one of the alignment techniques. Between the rods, addition of several multilayers from other materials may be necessary in order to control (a) the expansion of the evanescent field from the nanorods, (b) area with negative refractive index, (c) optical losses, and (d) the wavelength of the negative refractive index window. The number of added multilayers can accurately control the optical properties of the resulting material.

In accordance with various aspects of the present disclosure, the controlled orientation of anisotropic axial geometry nanoparticles, in polymer composites, suggests dramatic performance improvements for anisotropic nanoparticle-polymer composites in a wide range of applications. For example, the oriented SWNT-polymer composite can be used for artificial muscle or actuator applications and will possess improved directional electrical and mechanical properties. The biocompatibility of LBL SWNT composites and other SWNT composites for tissue engineering applications will accommodate mammalian cells which will grow along the direction of the SWNT orientation due to directed electrical potential during culturing. Directed anisotropic response of oriented nanoparticles have vast applicability for actuation, optical, biomedical and electronic applications of axial geometry/anisotropic nanoparticle/polymer composites.

In other aspects of the present disclosure, the multilayer assembly comprises a natural nanoparticle, namely cellulose nanocrystals (CellNs). These nanomaterials provide natural materials that have renewable origins, and further have impressive mechanical properties, such as bending strength of about 10 GPa and E about 150 GPa (Single-Walled CNTs have tensile strength predicted to be as high as about 300 GPa at E of about 1 TPa, and bending strength of 63 GPa). CellNs are inherently a low cost material and can be cultivated as nanocrystals from a variety of natural sources, including: cotton, tunicate, algae, bacteria, and wood. In certain aspects, cellulose nanocrystals can be prepared by the treatment of natural sources such as shrouds of tunicate, specific marine animals. These shrouds provide high quality cellulose nanocrystals with long fibers with diameter in nanometer range. Depending on the source, CellNs are also available in a wide variety of aspect ratios, e.g. about 200 nm long and 5 nm in lateral dimension and up to several microns long and 15 nm in lateral dimension (from cotton and tunicate respectively). As compared to other inorganic reinforcing fillers, CellNs have additional advantages, including positive ecological impact: low energy consumption, ease of recycling by combustion, high sound attenuation, and comparatively easy processability due to their nonabrasive nature, which allows high filling levels, in turn resulting in significant cost savings. CellNs are an attractive nanomaterial for the preparation of low cost, light-weight, and high-strength hybrid composites for multitude of applications.

As such, potential applications of these agro-fiber based composites include automotive, railways, aircraft, irrigation systems, furniture industries, and sports and leisure items. CellNs can be used in a diverse range of fields including, by way of non-limiting example, iridescent pigments, and biomolecular NMR studies, among others.

From the purely mechanical point of view, preparation of composites from micro fibrillated cellulose can possess bending strength as high as 370 MPa and E up to 19 GPa. CellNs in combination with silk fibroin can form a composite with tensile strength (σ) as high as 160 MPa and E approaching 12 GPa.

In accordance with one aspect of the present disclosure, it is believed that the layer-by-layer (LBL) assembly technique for composites immobilizes the reinforcing agent within the polymer matrix, and thus provides improved mechanical strength of the CelIN composites, reducing the gap between actual mechanical strength and theoretical mechanical strength.

In one aspect of the present disclosure, multilayer composites comprising CellNs and poly(dimethyldiallylammonium chloride) (PDDA) are high strength, low-cost and light-weight thin-films. The sequential deposition of the CellNs with LBL technique opens a new route for nanoscale organization of the material.

Cellulose nanocrystals can be prepared by sulfuric acid hydrolysis of Whatman No. 1 filter paper powder (98% cotton) as described in Fengel et al. Chemistry, Ultrastructure, Reactions; Walter de Gruyter: New York (1984), herein incorporated by reference in its entirety. Briefly, 5g of the ground paper is mixed with 100 mL of 64% w/v sulfuric acid and is stirred at 45 ° C. for 1 h. The acid solution is subsequently removed by multiple centrifugation, decantation of the supernatant, and redispersion steps. Purified material is finally redissolved in 100 mL of deionized water and stored in the refrigerator until further use. Prior to use in experiments, suspension with the crystals is redispersed by brief ultra-sonic treatment of the solution with an ultrasonic processor (commercially available from Cole-Parmer) in order to break up any of the aggregated material.

In a certain aspect, a multilayer LBL nanoscale composite comprises poly(diallyldimethylammonium chloride) PDDA as a polyelectrolyte. PDDA is widely available and its polymer chains contain a high density of positive charges per unit length which renders preparation of the multilayers easier as opposed to other weakly charged polyelectrolytes. Sulfuric acid hydrolysis of cotton fibers results in partial conversion of the hydroxyl groups to sulfates, thus imparting negative charges to the nanocrystals and requiring positively charged partner for the assembly.

### Example 2

Microscope glass slides are used as a substrate for the LBL assembly. The slides are cleaned by boiling in piranha solution (3:1 H₂SO₄:H₂O₂) for 1 hour, followed by thorough rinsing with de-ionized water prior to use.

A PDDA polymer with molecular weight of MW about 100,000 is purchased from Sigma-Aldrich (St. Louis, Mo.) and used as received (20 wt % solution) without further purification. The stock polymer solution is diluted to 0.5 wt % with 18 MΩ, de-ionized under vigorous stirring for 2 hours. Cellulose nanocrystals are prepared as described above by sulfuric acid hydrolysis. Whatman No. 1 filter paper and microscope glass slides are both obtained from Fisher Scientific (Hampton, N.H.). Hydrogen peroxide and concentrated sulfuric acid used in the piranha solution and nanocrystal preparation are commercially available from Sigma-Aldrich.

The cleaned glass slides are sequentially immersed into: 1) 0.5 wt % PDDA solution for 10 min, 2) DI water for 2 minutes in order to rinse any weakly adsorbed material, 3) cellulose nanocrystals solution for 10 min, and 4) DI water for 2 minutes to rinse away any weakly adsorbed CellNs. The entire cycle is then repeated up to ten times, however, the deposition can be repeated indefinitely to the desired thickness. The pH of the rinsing water after CellNs deposition is adjusted to pH=2-3, in the range of CellNs solution pH, because it shows more uniform growth of the multilayer. After every rinsing step, glass slides are thoroughly dried with compressed air stream before proceeding to the next deposition.

Samples prepared in accordance with Example 2 are tested with a scanning electron microscopy (SEM). SEM images are taken with a FEI Nova Nanolab Dualbeam FIB. The SEM sample consists of a single PDDA/CellNs bilayer deposited on a piece of a piranha cleaned silicon wafer following the same procedure as with glass slides. Prior to taking images, the sample is coated with a thin layer of gold using a vacuum gold ion sputterer to avoid the charging effect on the sample with the electron beam.

Atomic force microscopy (AFM) imaging was performed in air with a Nanoscope III (Digital Instruments/Veeco Metrology Group) operated in tapping mode using silicon/nitride tips. The sample is prepared in the same manner as for SEM analysis except no gold coating was required.

UV-vis spectroscopy is performed with an 8453 UV-Vis Chem Station spectrophotometer produced by Agilent Technologies. The measurements are obtained by acquiring the absorbance spectrum for a sample deposited on a clean glass slide from 200 nm to 1000 nm after each deposition of a material and comparing the spectrum to that of a pure glass slide. For the purpose of spectrum acquisition, the glass slide is placed directly in the path of light between the light source and the detector.

Ellipsometry measurements are obtained using a BASE-160 Spectroscopic Ellipsometer produced by J. A. Woollam Co., Inc. The samples used for ellipsometry are similar to those used for SEM and AFM. In particular, layers are deposited on the silicon wafer in the same manner as on glass slides and a scan is obtained after every CellNs layer up to 10 bilayers. The refractive index of the multilayer is determined from a thick sample. This value is then used for the thickness calculation of thin layers. The instrument is calibrated to the standard silicon wafer with a thin layer of silicon dioxide and the overall thickness on the wafer is then fitted using a Cauchy's model.

In a typical multilayer assembly, 10 min adsorption intervals are used. To monitor proper assembly, the classical approach is used where UV-vis absorbance spectrum is measured after each deposited bilayer on a glass slide. (FIG. 5A). When absorbance at 360 nm wavelength is plotted as a function of a bilayer number the graph gives nearly straight regression, indicating uniform assembly and distribution of CellNs in each bilayer. (FIG. 5A). The absorbance of the composite reached nearly 0.35 OD after deposition of 10 bilayers, indicating high loading of the CellNs and rapid LBL deposition, which can be contrasted with relatively slow deposition of SWNTs which is likely due to small surface charge.

The thickness of each individual bilayer in the composite is estimated using ellipsometry. The individual bilayer is 11 nm thick and this thickness is consistent for every additional bilayer added to the composite. A plot of the thickness data obtained from ellipsometry shows a straight line. (FIG. 5B). This result agrees with the UV-vis data collected.

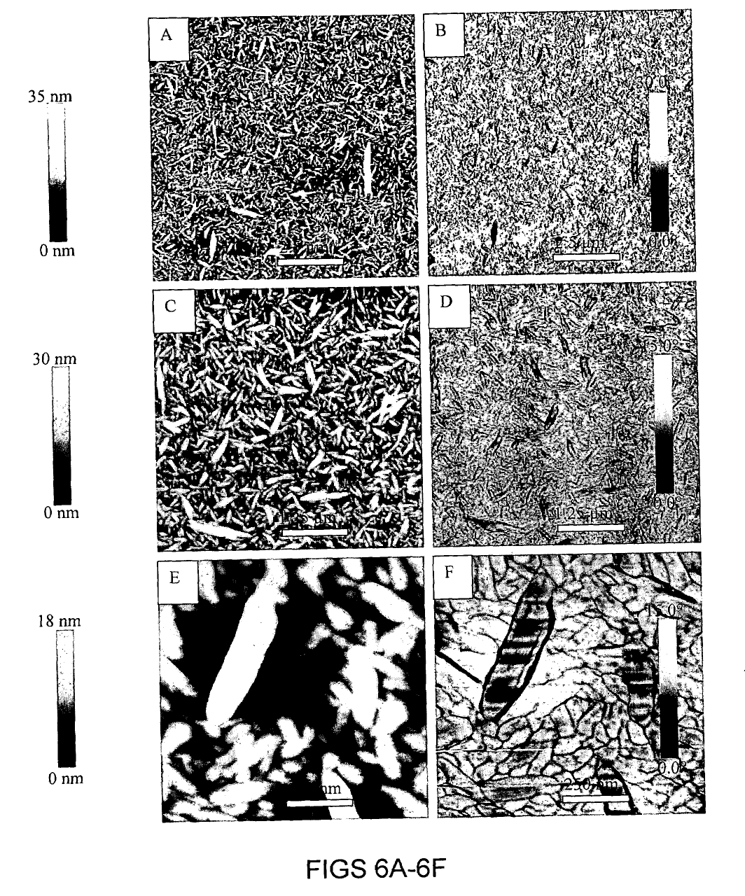

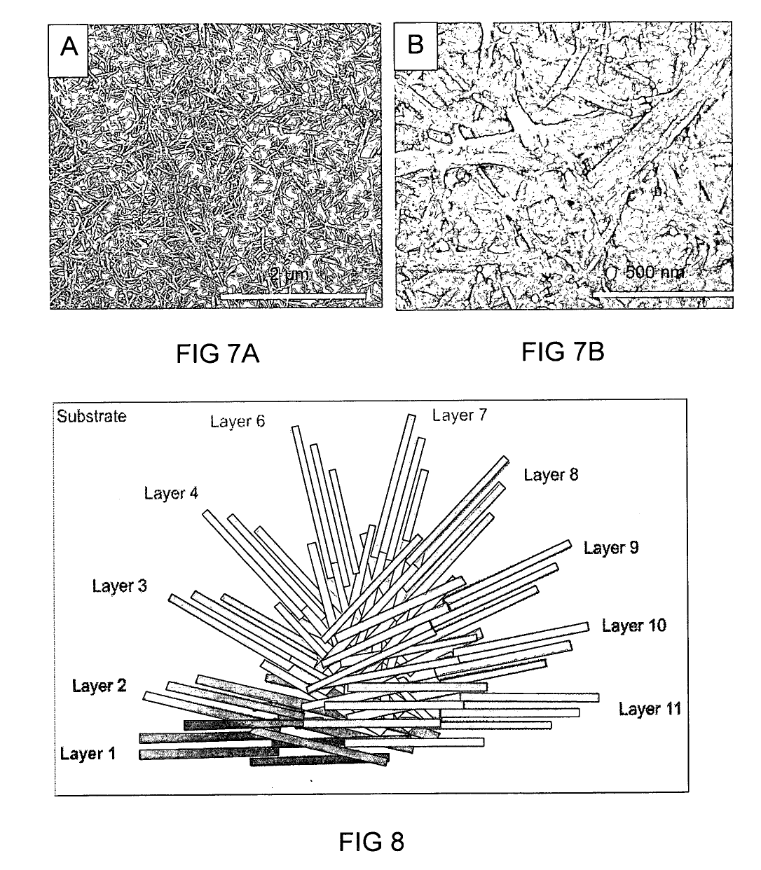

Surface morphology and topology of LBL layers of CellNs are characterized by atomic force microscopy (AFM) in FIGS. 6A-6F as well as scanning electron microscopy (SEM) in FIGS. 7A-7B. AFM images are obtained while operating in tapping mode, since CellNs have been found to be easily adsorbed on the tip of the probe operating in the contact mode when PDDA is present. Characterization of a single bilayer adsorbed on a silicon wafer reveals very high density and uniform coverage. (FIGS. 6A-6F). SEM characterization confirms high uniformity and dense packing obtained from AFM analysis (FIG. 7A-7B).

CellNs obtained from cotton have been reported to be 5 nm in diameter and 100-300 nm long, as corroborated by both SEM and AFM. SEM and AFM also show larger crystals (FIGS. 6C and 6D) which appear to be aggregates of CellNs resulting from incomplete digestion of cotton. To avoid these larger aggregates, further purification may be applied. The network morphology of the films is a very encouraging structural feature for the creation of ultra strong materials. Thus, in accordance with certain principles set forth in the present disclosure, LBL assembly using cellulose nanocrystals and PDDA polycation, can generate a new class of multilayered composites. The multilayer structure has tightly packed CellNs layers with high loading of the nanocrystals. Formation of a uniform layer allows for direct assembly of the nanocrystals with other nanocolloids without the need for polymeric interlayer. Given their natural origins, CellNs have wide potential for applications in biomedical community as well. Further, the combing procedures described previously above may be used in conjunction with the CellNs to provide alignment of the nanoparticles. Likewise, the heat treatment and annealing steps described above may also be used on the multilayer assembly.

The description of the present disclosure is merely exemplary in nature and, thus, variations that do not depart from the gist of the present disclosure are intended to be within the scope of the present disclosure. Such variations are not to be regarded as a departure from the spirit and scope of the present disclosure.

1. A method of making a layered material, the method comprising:
providing a substrate having a surface with at least one region having a charge;
forming a first layer by sequentially contacting said at least one region with a first solution and a second solution, where said first solution comprises a first charged species and said second solution comprises a second charged species, wherein said first charged species has a charge opposite to that of both said surface of said substrate and of said second charged species, wherein said first charged species comprises one of: an axial nanoparticle and a polyelectrolyte and wherein said second charged species comprises the other of: said axial nanoparticle and said polyelectrolyte, wherein said first charged species overlies said at least one region of the surface and said second charged species overlies said first charged species, thereby forming said first layer;
aligning said first layer comprising said axial nanoparticle and said polyelectrolyte to a first orientation;
forming a second layer by sequentially contacting said at least one region overlaid with said first layer with said first solution and said second solution; and
aligning said second layer comprising said axial nanoparticle and said polyelectrolyte to a second orientation.

2. The method according to claim 1, wherein said first orientation is distinct from said second orientation.

3. The method according to claim 1, wherein said aligning of said first layer and of said second layer comprises applying air over said surface.

4. The method according to claim 1, wherein at least one of said first layer and said second layer comprises a de-wetting component that is removed during said aligning.

5. The method according to claim 1, wherein said forming of said first layer and/or said forming of said second layer comprises cross-linking of said respective layer.

6. The method according to claim 1, wherein said axial nanoparticle comprises at least one of: nanotubes, nanofibers, nanorods, nanowires, and nanowhiskers.

7. The method according to claim 1, wherein said axial nanoparticle is formed of carbon, cellulose, silver, gold, and mixtures thereof.

8. The method according to claim 1, wherein said axial nanoparticle comprises carbon nanotubes.

9. The method according to claim 6, wherein said first solution comprises said carbon nanotubes and the method further comprises pre-treating said carbon nanotubes with a pre-treatment compound containing a charge, wherein said pre-treatment compound and said carbon nanotubes form said first charged species.

10. The method according to claim 7, wherein said pre-treatment compound is selected from the group consisting of: poly(4-styrene sulfonate) (PSS), poly-ethyleneimine, polyallylamine, polyvinyl alcohol (PVA), poly(acrylic) acid, polymers with condensed aromatic ring structures, amphiphilic co-polymers, DNA, proteins, surfactants, and mixtures thereof.

11. The method according to claim 1, wherein said polyelectrolytes are selected from the group consisting of: poly(dimethyldiallylammonium chloride) (PDDA), polyvinyl alcohol (PVA), poly(4-styrene sulfonate) (PSS) and mixtures thereof.

12. The method according to claim 1, wherein said axial nanoparticle comprises cellulose nanocrystals.

13-14. (canceled)

15. A multilayer material comprising:
a first gas-combed layer comprising a first polyelectrolyte and a first nanoparticle species having an axial geometry selected from a cylindrical, rod, and/or fibrous shape, wherein said first nanoparticle species are substantially aligned along a first orientation after gas-combing;
a second gas-combed layer comprising a second polyelectrolyte and a second nanoparticle species having an axial geometry selected from a cylindrical, rod, and/or fibrous shape, wherein said second nanoparticle species are substantially aligned along a second orientation after gas-combing which is distinct from said first orientation.

16. The material according to claim 15, wherein said first nanoparticle species and said second nanoparticle species are the same.

17. The material according to claim 15, wherein the material comprises a plurality of layers including said first gas-combed layer and said second gas-combed layer.

18. The material according to claim 17, wherein a respective angle of alignment occurs between a respective orientation of each adjacent gas-combed layer of said plurality, wherein the material has a constant shift in said angle of the alignment from one of each said gas-combed layer to the next gas-combed layer of said plurality, providing the material with lyotropic liquid crystal properties.

19. The material according to claim 15, wherein the material is a lyotropic liquid crystal material.

20. The material according to claim 15, wherein the material is a thermoelectric material.

21. The material according to claim 15, wherein the material is a robust nanocomposite material.

22. The material according to claim 15, wherein at least one of said first and said second nanoparticles species comprises: nanotubes, nanofibers, nanorods, nanowires, and nanowhiskers.

23. The material according to claim 15, wherein at least one of said first and said second nanoparticle species is formed of carbon, cellulose, silver, gold, and mixtures thereof.

24. The material according to claim 15, wherein at least one of said first and said second nanoparticle species comprises carbon nanotubes.

25. The material according to claim 15, wherein at least one of said first and said second nanoparticle species comprises cellulose nanocrystals.

26. The material according to claim 15, wherein at least one of said first and said second polyelectrolytes is selected from the group consisting of:
poly(dimethyldiallylammonium chloride) (PDDA), polyvinyl alcohol (PVA), poly(4-styrene sulfonate) (PSS) and mixtures thereof.

27. A method of making a layered material, the method comprising:
providing a substrate having a surface with at least one region having a charge;
forming a first layer by sequentially contacting said at least one region with a first solution and a second solution, where said first solution comprises a first charged species and said second solution comprises a second charged species, wherein said first charged species has a charge opposite to that of both said surface of said substrate and of said second charged species, wherein said first charged species comprises one of: an axial nanoparticle and a polyelectrolyte and wherein said second charged species comprises the other of: said axial nanoparticle and said polyelectrolyte, wherein said first charged species overlies said at least one region of the surface and said second charged species overlies said first charged species, thereby forming said first layer; and
aligning said first layer comprising said axial nanoparticle and said polyelectrolyte to a first orientation.

28. The method of making a layered material according to claim 27, further comprising forming a second layer by sequentially contacting said at least one region overlaid with said first layer with said first solution and said second solution; and
aligning said second layer comprising said axial nanoparticle and said polyelectrolyte to a second orientation.

29. The material according to claim 15, wherein greater than 80% of said first nanoparticle species is aligned along said first orientation by an angular deviation of less than ±5° after said gas-combing and greater than 80% of said second nanoparticle species is aligned along said second orientation by an angular deviation of less than ±5°.
